(19) United States
(12) Patent Application Publication
(10) Pub. No.: US 2024/0284812 A1
(43) Pub. Date: Aug. 29, 2024

(54) ELECTRIC WEEDER

(71) Applicant: Nanjing Chervon Industry Co., Ltd., Nanjing (CN)

(72) Inventors: Xu Wu, Nanjing (CN); Yonghui Cheng, Nanjing (CN); Shubin Tong, Nanjing (CN)

(21) Appl. No.: 18/457,714

(22) Filed: Aug. 29, 2023

(30) Foreign Application Priority Data
Feb. 27, 2023 (CN) 202310171930.2
Feb. 27, 2023 (CN) 202310180281.2

(51) Int. Cl. A01B 1/16

(52) U.S. Cl. CPC A01B 1/16

(57) ABSTRACT

An electric weeder includes a body and a working head. The body includes a drive mechanism. The drive mechanism includes a motor for driving the working head to rotate around a first axis. The drive mechanism has a first working mode in which the working head is screwed into a workplane and a second working mode in which the working head is unscrewed from the workplane. The direction of rotation of the working head in the first working mode is different from the direction of rotation of the working head in the second working mode. The output rotational speed of the working head is less than or equal to 400 RPM in the first working mode.

### RELATED APPLICATION INFORMATION

This application claims the benefit under 35 U.S.C. § 119(a) of Chinese Patent Application No. 202310171930.2, filed on Feb. 27, 2023, and Chinese Patent Application No. 202310180281.2, filed on Feb. 27, 2023, which applications are incorporated herein by reference in their entirety.

### TECHNICAL FIELD

The present application relates to a power tool for removing weeds in a lawn in a garden and, in particular, to an electric weeder.

### BACKGROUND

The traditional methods for removing lawn weeds in the related art include manual weeding and spraying of chemical herbicides. The residual herbicides cause certain chemical pollution and environmental pollution to the crops and soil, leading to the enhancement of herbicide resistance of the weeds and causing broad-spectrum herbicide resistance. The manual weeding includes manually using weeding digging tools and drill-like rotary tools on which a weeder head attachment is mounted for electric weeding. When using a short weeder, the user needs to squat for a long time to operate, which is prone to fatigue. When the user uses a drill mounted with a weeding head attachment for weeding operations, such a tool has high requirements for the user's operating ability. If the user does not operate properly, it is easy to cause the weeding head attachment to be thrown to useful crops.

This section provides the background information related to the present application which is not necessarily the existing art.

### SUMMARY

An electric weeder includes a body and a working head. The working head is driven by the body and is movably connected to the body. The body includes a housing for connecting a power supply and a drive mechanism accommodated in the housing. The drive mechanism includes a motor for driving the working head to rotate around a first axis. The drive mechanism has a first working mode in which the working head is screwed into a workplane and a second working mode in which the working head is unscrewed from the workplane, where the direction of rotation of the working head when the drive mechanism is in the first working mode is different from the direction of rotation of the working head when the drive mechanism is in the second working mode, and the output rotational speed of the working head is less than or equal to 400 RPM in the first working mode.

In some examples, the maximum output rotational speed of the working head in the second working mode is greater than or equal to the maximum output rotational speed of the working head in the first working mode.

In some examples, the drive mechanism further includes a transmission assembly for transmitting power outputted by the motor to the working head.

In some examples, the transmission assembly provides at least one deceleration ratio.

In some examples, the transmission assembly includes a planet gear deceleration assembly.

In some examples, the power supply includes a battery pack for supplying power to the motor.

In some examples, the battery pack is detachably connected to the housing, and after the battery pack is detached from the body, the battery pack adapts to another power tool and supplies power to another power tool.

In some examples, the nominal voltage of the battery pack is greater than or equal to 4 V and less than or equal to 80 V.

In some examples, the working head includes a weeder head located at the end of the working head and used for being screwed into the workplane and winding grass, a connection assembly extending along the first axis and connecting the weeder head to the body, and a grass unloading assembly driven to clean the weeder head.

In some examples, in the electric weeder, along a direction of the first axis, the distance L between the lower end of the weeder head and the upper end of the body is greater than or equal to 700 mm and less than or equal to 1300 mm.

In some examples, the body includes a switching portion configured to set a working mode of the drive mechanism to the first working mode or the second working mode.

In some examples, the switching portion is at least partially disposed on the housing.

In some examples, a grip mechanism is formed on or connected to the housing, where the grip mechanism includes a first handle and a second handle, and the first handle and the second handle are separately disposed on two sides of the first axis; and the included angle α between an orthographic projection of an axis of the first handle along a length direction on a plane perpendicular to the first axis and an orthographic projection of an axis of the second handle along a length direction on the plane perpendicular to the first axis is greater than 90° and less than 180º.

In some examples, the axis of the first handle along the length direction is basically perpendicular to the first axis, and the axis of the second handle along the length direction is basically perpendicular to the first axis.

In some examples, the power supply is disposed between the first handle and the second handle.

An electric weeder includes a body and a working head. The working head is driven by the body and is movably connected to the body. The body includes a housing for connecting a power supply and a drive mechanism accommodated in the housing. The drive mechanism includes a motor for driving the working head to rotate around a first axis and a transmission assembly for transmitting power outputted by the motor to the working head, where the transmission assembly includes a gear deceleration assembly; and in the electric weeder, along a direction of the first axis, the distance L between the lower end of the working head and the upper end of the body is greater than or equal to 700 mm and less than or equal to 1300 mm.

An electric weeder includes a body and a working head. The working head is driven by the body and is movably connected to the body. The body includes a housing for connecting a power supply and a drive mechanism accommodated in the housing. The drive mechanism includes a motor for driving the working head to rotate around a first axis and a transmission assembly for transmitting power outputted by the motor to the working head, where the transmission assembly includes a gear deceleration assembly; and the drive mechanism has a first working mode in which the working head is screwed into a workplane, and the output rotational speed of the working head is less than or equal to 400 RPM in the first working mode.

In some examples, the drive mechanism has a second working mode in which the working head is unscrewed from the workplane, and the direction of rotation of the motor in the first working mode is different from the direction of rotation of the motor in the second working mode.

In some examples, the power supply includes a battery pack for supplying power to the motor.

In some examples, the battery pack is detachably connected to the outer circumferential side of the housing.

### BRIEF DESCRIPTION OF THE DRAWINGS

FIG. 1 is a structural view of an example of an electric weeder;

FIG. 2 is a structural view of the electric weeder in FIG. 1 from another perspective;

FIG. 3 is an exploded view of the electric weeder in FIG. 1;

FIG. 4 is a sectional view of a body in FIG. 3;

FIG. 5 is a schematic view of a body in FIG. 3 from another perspective;

FIG. 6 is a schematic view of a body in FIG. 3 from another perspective;

FIG. 7 is an exploded view of a body in FIG. 3; and

FIG. 8 is an exploded view of a drive mechanism in FIG. 7.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

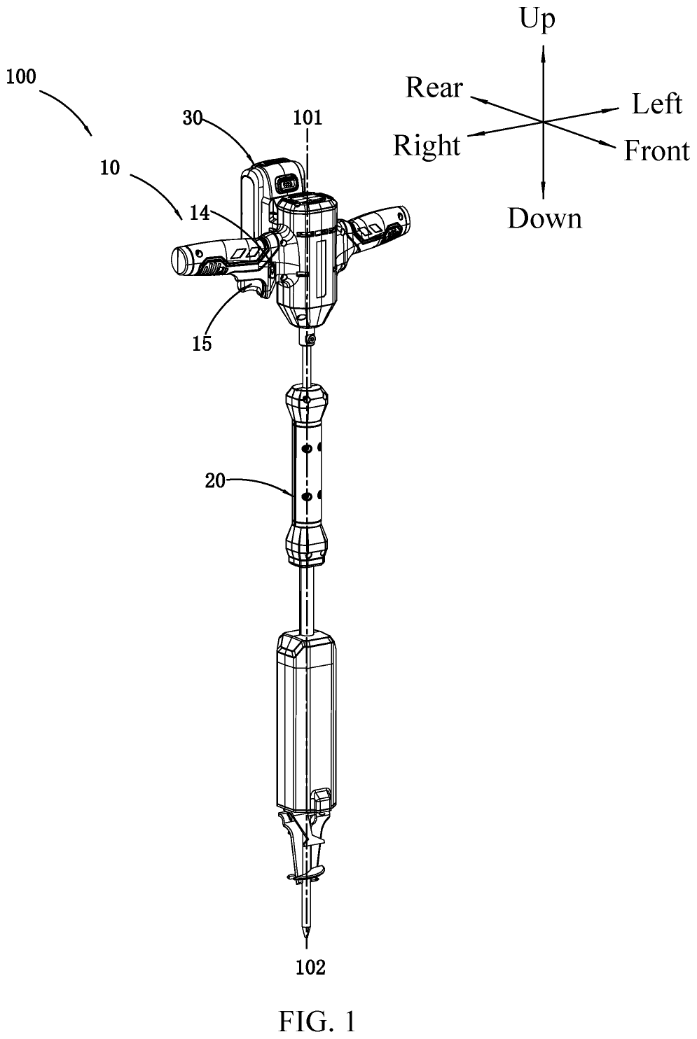

To describe technical solutions of the present application clearly, “upper side”, “lower side”, “left side”, “right side”, “front side”, and “rear side” as shown in FIG. 1 are further defined.

FIGS. 1 to 3 show an electric weeder 100 in an example of the present application. The electric weeder 100 includes a power supply 30. The power supply 30 is used for supplying electrical energy to the electric weeder 100. In this example, the power supply 30 is a battery pack, and the battery pack mates with a corresponding power supply circuit to supply power to the electric weeder 100. Those skilled in the art should understand that the power supply 30 is not limited to the scenario of using the battery pack and may be a built-in rechargeable battery or a standard battery. It is to be understood that the electric weeder 100 may also supply power to corresponding components in the body through mains power and alternating current (AC) power supply in conjunction with the corresponding rectifier circuit, filter circuit, and voltage regulator circuit. In the subsequent description, the battery pack 30 is used instead of the power supply, but it does not serve as a limitation to the present invention.

In this example, the battery pack 30 is a lithium battery pack, a solid-state battery pack, or a pouch battery pack. In some examples, the nominal voltage of the battery pack 30 is greater than or equal to 4 V and less than or equal to 80 V. In some examples, the nominal voltage of the battery pack 30 is 10.8 V, 12 V, 18 V, 24 V, 36 V, 48 V, 56 V, or 80 V. In some examples, the nominal voltage of the battery pack 30 is 20 V. The capacity of the battery pack 30 is 0.5 Ah to 12 Ah. In some examples, the capacity of the battery pack 30 is 2 Ah. The battery pack 30 is a platform battery pack, that is to say, after the battery pack 30 is detached from the electric weeder 100, the battery pack 30 can also supply power to another handheld power tool, a table power tool, a lighting tool, and a garden power tool.

As shown in FIGS. 1 to 3, the electric weeder 100 includes a body 10 and a working head 20. The working head 20 is used for performing weeding and grass unloading and may be understood as an execution component. In this example, the working head 20 is driven by the body 10 to work, and the working head 20 rotates around a first axis 102 to work. The working head 20 is movably connected to the body 10. In the working state of the electric weeder 100 (as shown in FIG. 1), the working head 20 is located below the body 10. The working head 20 has different specifications according to different materials of workplanes (which may be understood as the land) and different types of weeds to be removed. The working head 20 is detachably connected to the body 10, which is convenient for a user to replace and use the working head 20 with different specifications. In some examples, the working head 20 may be hinged with the body 10 to facilitate storage of the weeder.

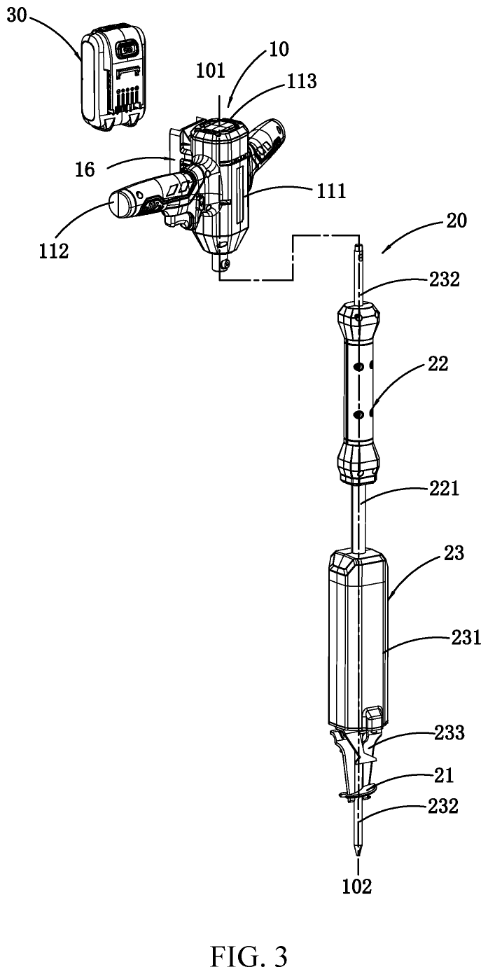

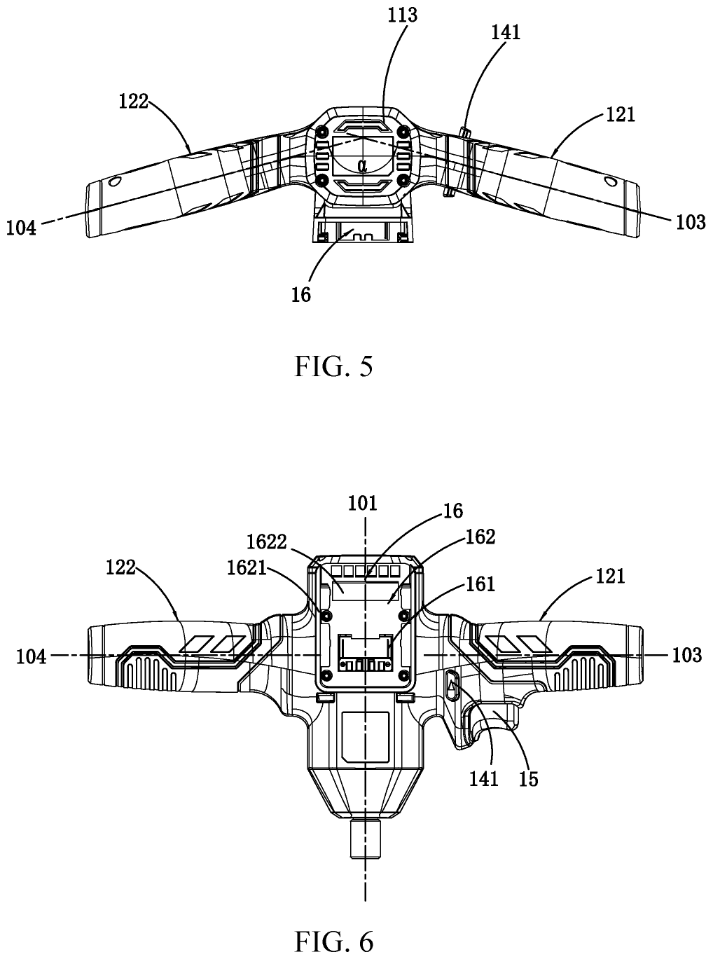

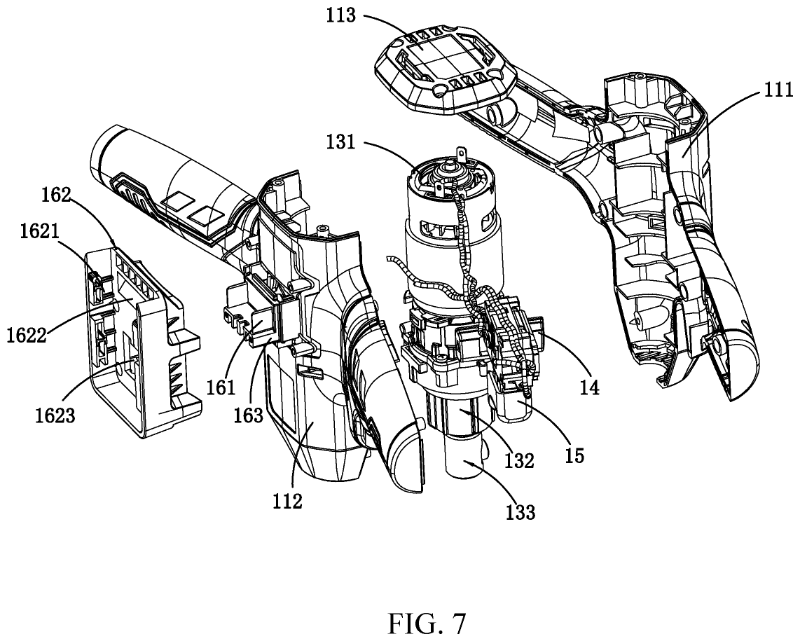

As shown in FIGS. 1 to 7, the body 10 includes a housing 11, a drive mechanism 13, and a grip mechanism 12. The housing 11 is formed with an accommodation space for accommodating at least part of the drive mechanism 13. The grip mechanism 12 is formed on or connected to the housing 11. In this example, the grip mechanism 12 is formed on the housing 11, that is to say, the grip mechanism 12 and the housing 11 are integrally formed. In this example, the housing 11 is a clamshell structure. As shown in FIGS. 3 and 7, the housing 11 includes a front housing 111 and a rear housing 112 in the front and rear direction. The front housing 111 is a housing away from the user, and the rear housing 112 is a housing closer to the user. The grip mechanism 12 is separately formed on the front housing 111 and the rear housing 112, and the complete grip mechanism 12 is formed after the front housing 111 and the rear housing 112 are spliced together. In this example, to facilitate the assembly of the drive mechanism 13 and the manufacture of the housing, the housing 11 further includes an upper cover 113, and the upper cover 113 covers the upper opening of the whole formed by splicing the front housing 111 and the rear housing 112 together. In this example, the battery pack 30 is mounted on the rear housing 112. In other alternative examples, the battery pack 30 is mounted on the front housing 111. In other alternative examples, the battery pack 30 is mounted on the upper cover 113. The position of the battery pack 30 adapts to the center of gravity of the whole machine. After the battery pack 30 and the body 10 are mounted, the center of gravity of the whole formed by the battery pack 30 and the body 10 is located near a rotation axis of the working head 20.

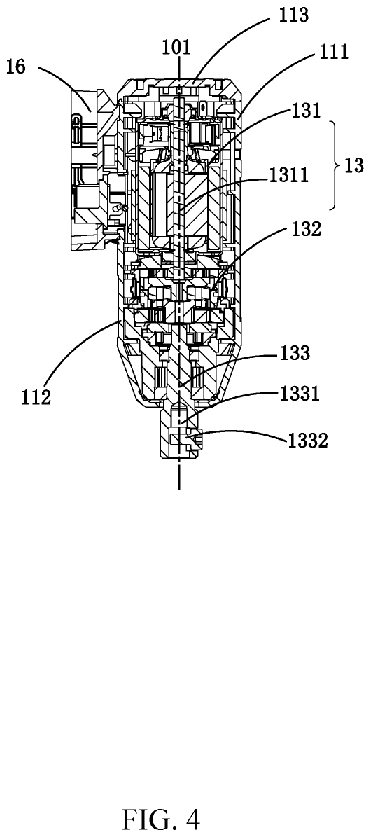

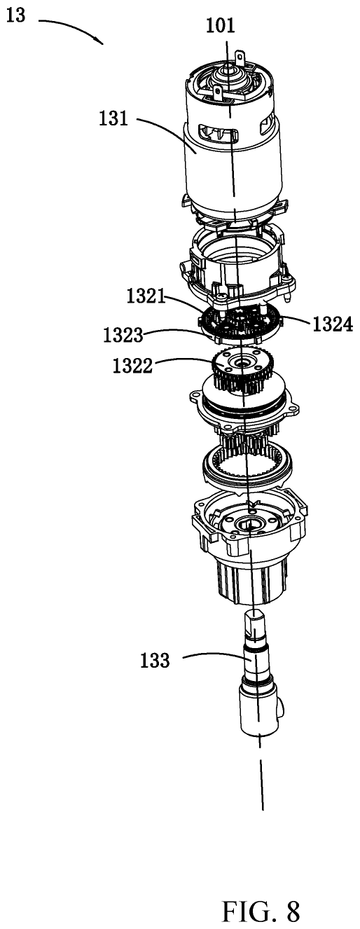

As shown in FIGS. 4 and 8, the drive mechanism 13 includes a motor 131 and a transmission assembly 132. The motor 131 is used for providing power to drive the working head 20 to rotate.

The motor 131 includes a drive shaft 1311 rotating around a main axis 101. In this example, the main axis 101 coincides with the first axis 102 of the working head 20. That is to say, the working head 20 rotates around the main axis 101. In some alternative examples, the first axis 102 of the working head 20 is parallel to the main axis 101 but does not coincide with the main axis 101. In some alternative examples, a certain included angle is formed between the first axis 102 of the working head 20 and the main axis 101. The above does not limit the substantive content of the present application. In this example, the motor 131 is specifically an electric motor. In the subsequent description, the electric motor 131 is used instead of the motor, but it does not serve as a limitation to the present invention. In this example, the electric motor 131 is a brushed direct current (DC) electric motor. The outer diameter of the electric motor 131 is 42 mm to 43 mm.

The transmission assembly 132 connects the electric motor 131 to the working head 20 and is used for transmitting the power of the electric motor 131 to the working head 20. The transmission assembly 132 includes a gear deceleration assembly and an output portion 133. The gear deceleration assembly transmits the output of the electric motor 131, and the speed decelerates and the torque increases during the transmission. A first end of the output portion 133 is connected to the gear deceleration assembly, and a second end of the output portion 133 is connected to the working head 20. In this example, the working head 20 is detachably connected to the output portion 133 through a first fastener 1332. In some examples, the working head 20 may be hinged with the output portion 133 by a hinge structure. It is to be explained that the first end of the output portion 133 and the second end of the output portion 133 do not necessarily refer to two opposite ends and may also be two adjacent ends. Alternatively, the end at which power is inputted to the output portion 133 is the first end, and the end at which the output portion 133 outputs power is the second end.

In this example, the drive mechanism 13 has a first working mode in which the working head 20 is screwed into the workplane and a second working mode in which the working head 20 is unscrewed from the workplane, where the direction of rotation of the working head 20 in the first working mode is different from the direction of rotation of the working head 20 in the second working mode. The direction of rotation of the drive shaft 1311 of the electric motor 131 in the first working mode is different from the direction of rotation of the drive shaft 1311 of the electric motor 131 in the second working mode. It is to be understood that, in the first working mode, the electric motor 131 drives the working head 20 to rotate around the first axis 102 along the first direction. In the second working mode, the electric motor 131 drives the working head 20 to rotate around the first axis 102 along the second direction. The first direction is the forward rotation direction of the electric motor 131, and the second direction is the reverse rotation direction of the electric motor 131. In some examples, the first direction may be the reverse rotation direction of the electric motor 131, and the second direction may be the forward rotation direction of the electric motor 131. In the related art, the electric weeder has only one working mode, that is, the electric motor 131 drives the working head 20 to be screwed into the workplane, the continuous rotation of the attachment on the working head 20 makes the weeds and the soil attached to the roots firmly screwed and wound around the attachment on the working head 20, then the electric motor 131 may be turned off, and the working head 20 is pulled out upward. In the process of pulling out the working head 20, the required pulling-out force is different when the soil quality and the amount of attached weeds are different. In the present application, the second working mode in which the direction of rotation is opposite to the screw-in direction is provided so that it is easier to pull out the electric weeder; and at the same time, during the reverse rotation process, the wound soil and grass roots can be separated from the working head 20, the damage to the workplane is little, the environmental pollution is little, and it is not easy to damage the cash crops around the weeds.

In the first working mode, the output rotational speed of the working head 20 is less than or equal to 400 RPM. In some examples, the output rotational speed of the working head 20 is less than or equal to 300 RPM, 250 RPM, 200 RPM, or 150 RPM. That is to say, the output rotational speed of the working head 20 ranges from 0 RPM to 400 RPM. In some examples, the output rotational speed of the working head 20 ranges from 0 RPM to 300 RPM. In some examples, the output rotational speed of the working head 20 ranges from 0 RPM to 250 RPM. In some examples, the output rotational speed of the working head 20 ranges from 0 RPM to 200 RPM. In some examples, the output rotational speed of the working head 20 ranges from 0 RPM to 150 RPM. Compared with the related art, the existing drill-like handheld tool is attached with a weeding tool head, and the body 10 of the electric weeder provides a smaller rotational speed, which is more conducive to the control of the weeder by the user during operation. Especially due to many stones or hard objects on the workplane in the use environment of the electric weeder, the high-speed rotating working head 20 generates large torque when the working head 20 is blocked by foreign objects, which is easy to damage the machine and the user; and the smaller rotational speed of the working head prevents the damage to the machine and the user.

The maximum output rotational speed of the working head 20 in the second working mode is greater than or equal to the maximum output rotational speed of the working head 20 in the first working mode. Since the second working mode is to unscrew the working head 20 from the workplane and the wound soil and grass roots can be separated from the working head 20, the rotational speed of the working head 20 in the second working mode is not required to be the same as the rotational speed of the working head 20 in the first working mode. At the same time, to improve the working efficiency and speed up the removal of the attached things, the maximum output rotational speed of the working head 20 in the second working mode may be greater than the maximum output rotational speed of the working head 20 in the first working mode. It is to be understood that when the maximum output rotational speed of the working head 20 in the first working mode is 150 RPM, the maximum output rotational speed of the working head 20 in the second working mode is 150 RPM or greater than 150 RPM, such as 200 RPM. That is to say, the output rotational speed of the working head 20 in the second working mode ranges from 0 RPM to 150 RPM and may also range from 0 RPM to 200 RPM. It is to be explained that the “maximum output rotational speed” refers to the output rotational speed that the electric weeder can reach in the working process or the output rotational speed set in a normal working mode. The electric weeder may not necessarily work at the maximum output rotational speed every time the electric weeder starts or works.

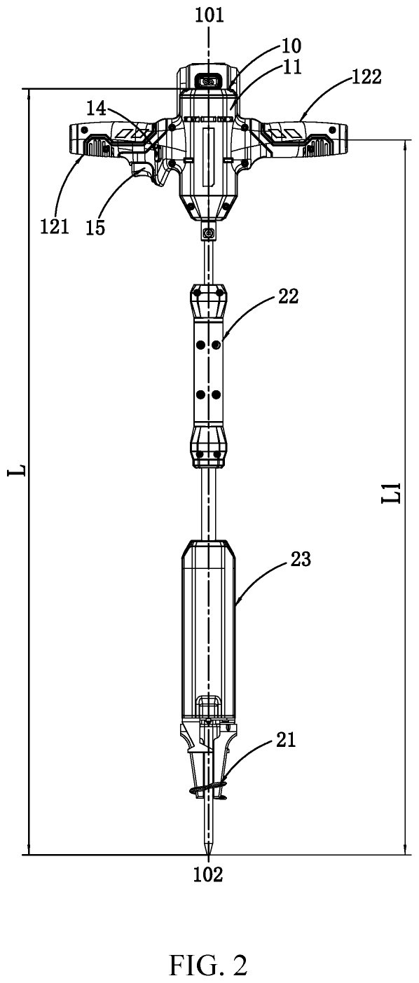

As shown in FIG. 2, the overall length L of the whole formed by the body 10 and the working head 20 of the electric weeder 100 along the direction of the first axis 102 is greater than or equal to 700 mm and less than or equal to 1300 mm. In this example, the overall length is the distance L between the lower end of the working head 20 and the upper end of the body 10. In some examples, the distance L between the lower end of the working head 20 and the upper end of the body 10 is greater than or equal to 800 mm and less than or equal to 1000 mm. A better user experience is ensured. The user may complete the process of weeding and grass removal in a standing state without repeatedly bending over or squatting down. Along the direction of the first axis 102, the distance L1 between the point of application of force on the grip mechanism 12 and the lower end of the working head 20 is greater than or equal to 780 mm and less than or equal to 990 mm. A better grip height is provided.

As shown in FIGS. 3 to 6, the grip mechanism 12 includes a first handle 121 and a second handle 122. The first handle 121 and the second handle 122 are separately disposed on two sides of the first axis 102. In this example, the first handle 121 and the second handle 122 are separately disposed on two sides of the main axis 101. It is to be understood that the first handle 121 and the second handle 122 separately correspond to two hands of the user. To facilitate holding, the first handle 121 and the second handle 122 are separately disposed on the left side and the right side of the main axis 101. The included angle α between an orthographic projection of an axis 103 of the first handle 121 along a length direction on a plane perpendicular to the main axis 101 and an orthographic projection of an axis 104 of the second handle 122 along a length direction on the plane perpendicular to the main axis 101 is greater than 90° and less than 180º. In some examples, the included angle α is greater than or equal to 120° and less than or equal to 180º. It is to be explained that the first handle 121 and the second handle 122 are gripping components where at least one point of application of the controlling force provided by the user is located. The overall appearance structure of the grip mechanism 12 may be the same as or different from the overall appearance of the first handle 121 and the second handle 122. The length direction is the direction of the line connecting the body 10 and the point of application of force of the user on the first handle 121 or the second handle 122. In this example, each of the first handle 121 and the second handle 122 is in the shape of a straight rod, and the length direction is the length extension direction. The axis 103 of the first handle 121 along the length direction is basically perpendicular to the main axis 101, and the axis 104 of the second handle 122 along the length direction is basically perpendicular to the main axis 101. In other alternative examples, the specific shape of the grip mechanism 12 is changed into a curved rod, an annular tube, or a steering wheel according to different appearance requirements. The preceding specific appearance shape of the grip mechanism 12 does not limit the content of the present application. In this example, the battery pack 30 is disposed between the first handle 121 and the second handle 122 so that the position of the center of gravity of the whole machine is more in line with usage habits.

In this example, the body 10 includes a main switch 15 and a switching portion 14. The main switch 15 and the switching portion 14 are both disposed on the grip mechanism 12. The main switch 15 is used for controlling the start and stop of the electric motor 131, and the main switch 15 is disposed on the first handle 121 or the second handle 122. The switching portion 14 is configured to set the working mode of the drive mechanism 13 to the first working mode or the second working mode, and the switching portion 14 is disposed on the first handle 121 or the second handle 122. As shown in FIGS. 1 and 2 and FIGS. 5 to 7, the main switch 15 and the switching portion 14 are both disposed on the first handle 121. In some examples, the main switch 15 and the switching portion 14 are both disposed on the second handle 122. In other alternative examples, the switching portion 14 includes a first switching member for setting the working mode of the drive mechanism 13 to the first working mode and a second switching member for setting the working mode of the drive mechanism 13 to the second working mode, where the first switching member and the second switching member are located on the first handle 121 and the second handle 122, respectively. In other alternative examples, the main switch 15 includes a start switch and a brake switch, and when the start switch is triggered, the electric motor 131 starts to rotate. When the brake switch is triggered, the electric motor 131 stops rotating. The start switch and the brake switch are both disposed on the first handle 121 or the second handle 122. Alternatively, the start switch and the brake switch are disposed on the first handle 121 and the second handle 122, respectively.

In this example, the main switch 15 is a trigger switch. The rotational speed of the electric motor 131 is adjusted according to the trigger stroke of the trigger switch. In this example, the trigger switch is coupled with a sliding rheostat, the trigger strokes of the trigger switch are different, and the analog signals outputted by the sliding rheostat are different. The trigger stroke of the trigger switch is positively correlated to the duty cycle of the pulse-width modulation (PWM) signal of the electric motor 131, and the duty cycle of the PWM signal is positively correlated to the rotational speed of the electric motor 131. When the trigger stroke of the trigger switch is relatively small, the duty cycle of the PWM signal is also relatively small, and in this case, the rotational speed of the electric motor 131 is also relatively small.

In some examples, the mapping relationship between the trigger stroke of the trigger switch and the PWM signal is stored in the electric weeder, where the mapping relationship may be linear or non-linear, which is not limited in the examples of the present application.

The switching portion 14 is a mechanical trigger structure. In this example, the switching portion 14 includes a toggle button 141 and a forward and reverse switch. Different positions of the toggle button 141 are triggered so that the corresponding contacts in the forward and reverse switch change, and the different contacts lead to positive and negative switching of the voltage applied between two ends of the electric motor 131, thereby achieving the forward and reverse switching of the electric motor 131. The toggle button 141 partially protrudes from the first handle 121. In this example, the toggle button 141 is disposed along an axis perpendicular to the first handle 121. The switching portion 14 is disposed above the main switch 15.

As shown in FIG. 8, the gear deceleration assembly is a planet gear deceleration assembly, and the planet gear deceleration assembly includes multi-stage planetary gearset transmission. Each stage of planetary gearset transmission includes at least one planet gear 1321, a planet carrier 1322 for mounting the planet gear, and an inner ring gear 1323 engaged with the planet gear. A sun gear 1324 is formed on or connected to the drive shaft 1311 and used for inputting the power of the electric motor into the gear deceleration assembly.

According to different specific requirements for the transmission ratio, one or more stages of planetary gearsets may be provided. The above does not affect the substantive content of the present application. In this example, three stages of planetary gearsets are included. In this example, the three stages of planetary gearsets are provided with one transmission state, that is to say, the gear deceleration assembly provides one deceleration ratio. The transmission ratio of the gear deceleration assembly is greater than or equal to 10. In some examples, the transmission ratio of the gear deceleration assembly is greater than or equal to 20. In some examples, the transmission ratio of the gear deceleration assembly is greater than or equal to 30. In some examples, the transmission ratio of the gear deceleration assembly is greater than or equal to 40. In some examples, the transmission ratio of the gear deceleration assembly is greater than or equal to 50. In this manner, the working head 20 has a relatively low output rotational speed in the first working mode.

In some examples, the inner ring gear of at least one stage of planetary gearset is configured to move between a first position and a second position to switch the transmission ratio of the gear deceleration assembly.

The working principle of the deceleration performed by the planet gear and the mechanical transmission ratio adjustment and the deceleration performed by this transmission mechanism have been completely disclosed to those skilled in the art. Therefore, a detailed description is omitted herein for the brevity of the specification.

The output portion 133 is connected to the output end of the gear deceleration assembly. A rotation axis of the output portion 133 coincides with or is parallel to the first axis 102. In this example, the rotation axis of the output portion 133 coincides with the main axis 101. In some examples, the rotation axis of the output portion 133 is parallel to the main axis 101 but does not coincide with the main axis 101. In some examples, a certain included angle is formed between the rotation axis of the output portion 133 and the main axis 101. A clamping portion 1331 is disposed at the second end of the output portion 133, and the clamping portion 1331 is provided with a universal accommodation groove for adapting to the interface of the working head 20. In some examples, the clamping portion 1331 further includes an adapter interface, where an end of the adapter interface is a universal interface, and the other end of the adapter interface is used for adapting to the working heads 20 with some special interfaces. The clamping portion 1331 further includes the first fastener 1332 for detachably connecting the working head 20 to the output portion 133.

As shown in FIGS. 1 to 3, the working head 20 includes a weeder head 21, a connection assembly 22, and a grass unloading assembly 23. The weeder head 21 is located at the end of the working head 20 and used for being screwed into the workplane and winding grass. The connection assembly 22 extends along the first axis 102 and connects the weeder head 21 to the body 10. The grass unloading assembly 23 is driven to clean the weeder head 21. The connection assembly 22 includes a connecting rod 221 extending along the first axis 102. The grass unloading assembly 23 is disposed between the connection assembly 22 and the weeder head 21. The grass unloading assembly 23 includes a grass unloading push handle 231, a grass unloading push rod 232, a grass unloading plate 233, and a reset portion (not shown in the figure). The grass unloading push handle 231 is driven by the user to start the grass unloading operation. The grass unloading push rod 232 extends along the first axis 102 and is connected to the weeder head 21. In this example, the grass unloading push rod 232 extends into the connection assembly 22 and is connected to the output portion 133. The grass unloading plate 233 is driven by the grass unloading push handle 231 to peel off the entanglement on the weeder head 21. The reset portion (not shown in the figure) is used for resetting the grass unloading push handle 231 to an initial state when a driving force on the grass unloading push handle 231 is removed. In this example, the reset portion (not shown in the figure) is a spring. In this example, the components on the working head 20 as a whole rotate synchronously when driven by the electric motor 131.

During working, the weeder head 21 is first inserted into the soil at the position of the root of the weed, and the electric motor 131 is started in the first working mode. The electric motor 131 is energized to make the drive shaft 1311 rotate, and the rotating drive shaft 1311 drives the working head 20 to rotate as a whole. The weeder head 21 rotates and then is screwed into the soil. The continuous rotation of the weeder head 21 makes the weeds and the soil attached to the roots firmly screwed and wound around the weeder head 21. After the weeding is completed, the electric motor 131 is turned off. The working mode switches to the second working mode, and the electric motor 131 is started in the second working mode. When the electric motor 131 drives the weeder head 21 to rotate in the reverse direction, the weeder head 21 is unscrewed upward from the soil. At this time, the weeder head 21 takes the weeds and soil out of the ground together to complete the weeding operation. The next step is the grass unloading. The grass unloading push handle 231 of the grass unloading assembly 23 is pushed, and the grass unloading plate 233 moves downward synchronously along the weeder head 21. Since the grass unloading plate 233 is initially located near the top of the weeder head 21, when moving downward, the grass unloading plate 233 can push off the weeds and soil wound around the weeder head 21 along the axial direction so that the weeds can be separated from the weeder head 21 to complete the grass unloading operation, and the next weeding operation can be performed.

As shown in FIGS. 3 to 7, the body 10 further includes a battery mounting assembly 16 for detachably connecting the battery pack 30. The battery mounting assembly 16 includes a connection terminal 161 and a battery mounting housing 162. In this example, the battery mounting assembly 16 is disposed on the rear housing 112 and located between the first handle 121 and the second handle 122. The connection terminal 161 at least partially protrudes from the rear housing 112 and is used for being electrically connected to the output terminal of the battery pack 30. The rest of the connection terminal 161 is disposed in the housing 11 and connected to the cable. The connection terminal 161 is fixedly connected to the rear housing 112 through a connecting seat 163. The battery mounting housing 162 is detachably connected to the rear housing 112. The battery mounting housing 162 includes a guide portion 1621 for guiding the mounting direction of the battery pack 30, an engagement portion 1622 for holding the battery pack 30, and an accommodation portion 1623 for accommodating the connection terminal 161. The accommodation portion 1623 is a through hole capable of accommodating the connection terminal 161. The guide portion 1621 includes grooves extending along the mounting direction of the battery pack 30 and arranged symmetrically. In this example, the battery pack 30 is inserted and pulled out along a direction parallel to the first axis 102, that is to say, the battery pack 30 is mounted to the body 10 along the up and down direction. In the up and down direction, the battery pack 30 partially protrudes from the upper cover 113 of the body 10. The engagement portion 1622 corresponds to the latch structure on the battery pack 30, and the battery pack 30 is held on the body 10. The battery mounting housing 162 is detachably connected to the housing 11 through fasteners so that the components are conveniently assembled, which is conducive to the replacement of accessories for the battery mounting housing 162.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. An electric weeder, comprising:
a body comprising a housing for connecting a power supply and a drive mechanism at least partly accommodated in the housing; and
a working head driven by the body and movably connected to the body,
wherein the drive mechanism comprises a motor for driving the working head to rotate around a first axis, the drive mechanism has a first working mode in which the drive mechanism drives the working head to screw into a workplane and a second working mode in which the drive mechanism drives the working head to screw out of the workplane, a direction of rotation of the working head when the drive mechanism is in the first working mode is different from a direction of rotation of the working head when the drive mechanism is in the second working mode, and an output rotational speed of the working head is less than or equal to 400 RPM in the first working mode.

2. The electric weeder of claim 1, wherein a maximum output rotational speed of the working head in the second working mode is greater than or equal to a maximum output rotational speed of the working head in the first working mode.

3. The electric weeder of claim 1, wherein the drive mechanism further comprises a transmission assembly for transmitting power outputted by the motor to the working head.

4. The electric weeder of claim 3, wherein the transmission assembly provides at least one deceleration ratio.

5. The electric weeder of claim 3, wherein the transmission assembly comprises a planet gear deceleration assembly.

6. The electric weeder of claim 1, wherein the power supply comprises a battery pack for supplying power to the motor.

7. The electric weeder of claim 6, wherein the battery pack is detachably connected to the housing, and the battery pack is configured to adapt to another power tool and supplies power to another power tool when the battery pack is detached from the body.

8. The electric weeder of claim 6, wherein a nominal voltage of the battery pack is greater than or equal to 4 V and less than or equal to 80 V.

9. The electric weeder of claim 1, wherein the working head comprises:
a weeder head located at an end of the working head and used for being screwed into the workplane and winding grass;
a connection assembly extending along the first axis and connecting the weeder head to the body; and
a grass unloading assembly driven to clean the weeder head.

10. The electric weeder of claim 9, wherein, along a direction of the first axis, a distance L between a lower end of the weeder head and an upper end of the body is greater than or equal to 700 mm and less than or equal to 1300 mm.

11. The electric weeder of claim 1, wherein the body further comprises a switching portion configured to set a working mode of the drive mechanism to the first working mode or the second working mode.

12. The electric weeder of claim 11, wherein the switching portion is at least partially disposed on the housing.

13. The electric weeder of claim 1, further comprising a grip mechanism formed on or connected to the housing, wherein the grip mechanism comprises a first handle and a second handle, the first handle and the second handle are separately disposed on two sides of the first axis, an included angle α between an orthographic projection of an axis of the first handle along a length direction on a plane perpendicular to the first axis and an orthographic projection of an axis of the second handle along a length direction on the plane perpendicular to the first axis is greater than 90° and less than 180°.

14. The electric weeder of claim 13, wherein the axis of the first handle along the length direction is basically perpendicular to the first axis, and the axis of the second handle along the length direction is basically perpendicular to the first axis.

15. The electric weeder of claim 13, wherein the power supply is disposed between the first handle and the second handle.

16. An electric weeder, comprising:
a body comprising a housing for connecting a power supply and a drive mechanism at least partly accommodated in the housing; and
a working head driven by the body and movably connected to the body,
wherein the drive mechanism comprises a motor for driving the working head to rotate around a first axis and a transmission assembly for transmitting power outputted by the motor to the working head, the transmission assembly comprises a gear deceleration assembly, and, along a direction of the first axis, a distance L between a lower end of the working head and an upper end of the body is greater than or equal to 700 mm and less than or equal to 1300 mm.

17. An electric weeder, comprising:
a body comprising a housing for connecting a power supply and a drive mechanism accommodated in the housing; and
a working head driven by the body and movably connected to the body,
wherein the drive mechanism comprises a motor for driving the working head to rotate around a first axis and a transmission assembly for transmitting power outputted by the motor to the working head, the transmission assembly comprises a gear deceleration assembly, the drive mechanism has a first working mode in which the drive mechanism drives the working head to screw into a workplane, and an output rotational speed of the working head is less than or equal to 400 RPM in the first working mode.

18. The electric weeder of claim 17, wherein the drive mechanism has a second working mode in which the drive mechanism drives the working head to screw out of the workplane, and a direction of rotation of the working head when the drive mechanism is in the first working mode is different from a direction of rotation of the working head when the drive mechanism is in the second working mode.

19. The electric weeder of claim 17, wherein the power supply comprises a battery pack for supplying power to the motor.

20. The electric weeder of claim 19, wherein the battery pack is detachably connected to an outer sidewall of the housing.
